(19) United States
(12) Patent Application Publication
(10) Pub. No.: US 2026/0002952 A1
(43) Pub. Date: Jan. 1, 2026

(54) DEVICES AND METHODS FOR TRAINING SAMPLE CONTAINER IDENTIFICATION NETWORKS IN DIAGNOSTIC LABORATORY SYSTEMS

(71) Applicant: Siemens Healthcare Diagnostics Inc., Tarrytown, NY (US)

(72) Inventors: Walid Bekhtaoui, Lawrence Township, NJ (US); Yao-Jen Chang, Princeton, NJ (US); Benjamin S. Pollack, Jersey City, NJ (US); Vivek Singh, Princeton, NJ (US); Ankur Kapoor, Plainsboro, NJ (US)

(73) Assignee: Siemens Healthcare Diagnostics Inc., Tarrytown, NY (US)

(21) Appl. No.: 19/107,692

(22) PCT Filed: Sep. 7, 2023
(86) PCT No.: PCT/US2023/073616

§ 371 Date: Feb. 28, 2025

Related U.S. Application Data
(60) Provisional application No. 63/374,889, filed on Sep. 7, 2022.

(51) Int. Cl. G01N 35/00; G06N 3/0895; G06V 10/764; G06V 10/774; G06V 10/82

(52) U.S. Cl. CPC G01N 35/00732; G06N 3/0895; G06V 10/764; G06V 10/774; G06V 10/82

(57) ABSTRACT

A method of training a sample container identification network of a diagnostic laboratory system includes obtaining a plurality of data subsets, wherein each data subset is smaller than a full training data set used to train the sample container identification network and includes a plurality of images of one or more sample containers. The sample container identification network is trained on each of the plurality of data subsets to generate a plurality of trained sample container identification networks. Each of the trained sample container identification networks are testing using testing data that includes test images of sample containers, wherein the testing includes identifying the sample containers in the test images. A core data set is selected from one of the plurality of data subsets based on the testing. the core data set for use in training a deployed sample container identification network. Other methods and systems are disclosed.

### CROSS REFERENCE TO RELATED APPLICATION

This application claims the benefit of U.S. Provisional Patent Application No. 63/374,889, entitled “DEVICES AND METHODS FOR TRAINING SAMPLE CONTAINER IDENTIFICATION NETWORKS IN DIAGNOSTIC LABORATORY SYSTEMS” filed Sep. 7, 2022, the disclosure of which is hereby incorporated by reference in its entirety for all purposes.

### FIELD

Embodiments of the present disclosure relate to devices and methods for training sample container identification networks in diagnostic laboratory systems.

### BACKGROUND

Diagnostic laboratory systems conduct clinical chemistry or assays to identify and/or quantify analytes or other constituents in biological samples such as blood serum, blood plasma, urine, interstitial liquid, cerebrospinal liquids, and the like. The samples may be received in and/or transported throughout such laboratory systems in sample containers. Such laboratory systems may process large volumes of sample containers and the samples contained therein.

Some laboratory systems use machine vision and machine learning to facilitate sample processing and sample container identification, which may be based on characterization and/or classification of the sample containers. For example, vision-based machine learning models (e.g., artificial intelligence (AI) networks) have been adapted to provide fast and noninvasive methods for sample container identification. However, the training cost for adding new types of sample containers to the machine learning models can be excessive because of the large amounts of training data that may be needed to retrain or adapt the machine learning models to identify the new types of sample containers.

Therefore, a need exists for laboratory systems and methods that improve training of machine vision systems in diagnostic laboratory systems.

### SUMMARY

According to a first aspect, a method of training a sample container identification network of a diagnostic laboratory system is provided. The method comprises obtaining a plurality of data subsets, wherein each data subset is smaller than a full training data set used to train the sample container identification network and includes a plurality of images of one or more sample containers, training the sample container identification network on each of the plurality of data subsets to generate a plurality of trained sample container identification networks, testing each of the trained sample container identification networks using testing data that includes test images of sample containers, wherein the testing includes identifying the sample containers in the test images, and selecting a core data set from one of the plurality of data subsets based on the testing, the core data set for use in training a deployed sample container identification network.

According to another aspect, a method of retraining a deployed sample container identification network of a diagnostic laboratory system is provided. The method comprises capturing an original image of a sample container using an imaging device within the diagnostic laboratory system, attempting to identify the sample container using the deployed sample container identification network to analyze the original image, the deployed sample container identification network trained on a full training data set, allowing the original image to be added to a core data set if the deployed sample container identification network fails to identify the sample container, and retraining the deployed sample container identification network using the core data set, wherein the core data set is smaller than the full training data set.

According to another aspect, a diagnostic laboratory system is provided. The diagnostic laboratory system comprises a track, a sample carrier moveable on the track and configured to receive a sample container including a sample, an imaging device configured to capture images of the sample container, a memory that includes a sample container identification network, the sample container identification network trained on a full training data set, a computer coupled to the imaging device and the memory, and computer program code that, when executed by the computer, causes the computer to: employ the imaging device to capture an image of a sample container within the diagnostic laboratory system, attempt to identify the sample container by analyzing the captured image using the sample container identification network, add the captured image to a core data set if the sample container identification network fails to identify the sample container, wherein the core data set is smaller than the full training data set, and allow the sample container identification network to be retrained using the core data set.

Still other aspects, features, and advantages of this disclosure may be readily apparent from the following description and illustration of a number of example embodiments, including the best mode contemplated for carrying out the disclosure. This disclosure may also be capable of other and different embodiments, and its several details may be modified in various respects, all without departing from the scope of the disclosure.

### BRIEF DESCRIPTION OF THE DRAWINGS

The drawings, described below, are provided for illustrative purposes, and are not necessarily drawn to scale. Accordingly, the drawings and descriptions are to be regarded as illustrative in nature, and not as restrictive. The drawings are not intended to limit the scope of the disclosure in any way.

FIG. 1 illustrates a block diagram of a diagnostic laboratory system including a sample handler according to one or more embodiments.

FIG. 2 illustrates a top plan view of an interior of a sampler handler of a diagnostic laboratory system according to one or more embodiments.

FIGS. 3A-3C illustrate different types of sample containers including tubes with attached caps that may be used within a diagnostic laboratory system according to one or more embodiments.

FIGS. 4A-4C illustrate different types of sample containers devoid of caps that may be used within a diagnostic laboratory system according to one or more embodiments.

FIG. 5 illustrates a perspective view of a robot of a sample handler of a diagnostic laboratory system including a gantry that is configured to move the sample handler and an attached imaging device along x, y, and z axes according to one or more embodiments.

FIG. 6 illustrates a side elevation view of the robot of FIG. 5 wherein the imaging device is configured and operative to capture images of a sample container according to one or more embodiments.

FIGS. 7A-7E illustrate an original image and augmented images of sample containers used to train a sample container identification network of a diagnostic laboratory system according to one or more embodiments.

FIGS. 8A-8E illustrate another example of an original image and augmented images of a sample container used to train a sample container identification network of a diagnostic laboratory system according to one or more embodiments.

FIG. 9 illustrates a workflow illustrating contrastive learning used to train a sample container identification network of a diagnostic laboratory system according to one or more embodiments.

FIG. 10 illustrates of a training network that may be implemented in the sample container identification network of FIG. 1 to train the sample container identification network per the workflow of FIG. 9 according to one or more embodiments.

FIG. 11 illustrates a diagram describing a method configured to select a core data set from a plurality of data subsets to train a sample container identification network of a diagnostic laboratory system according to one or more embodiments.

FIG. 12 illustrates a workflow of a method of determining whether to add an image of a sample container to a core data set configured to train a sample container identification network of a diagnostic laboratory system according to one or more embodiments.

FIG. 13 illustrates a flowchart of a method of training a sample container identification network of a diagnostic laboratory system according to one or more embodiments.

FIG. 14 illustrates a flowchart of a method of retraining a deployed sample container identification network of a diagnostic laboratory system according to one or more embodiments.

### DETAILED DESCRIPTION

As described herein, diagnostic laboratory systems conduct clinical chemistry and/or assays to identify analytes or other constituents in biological samples (hereinafter “samples”) such as blood serum, blood plasma, urine, interstitial liquid, cerebrospinal liquids, and the like. The samples are collected in sample containers and then delivered to a diagnostic laboratory system. The sample containers are subsequently loaded into a sample handler of the diagnostic laboratory system, and then transferred to sample carriers by a suitable robot. The sample carriers transport the sample containers to instruments, analyzers, and components of the diagnostic laboratory system where the samples are processed and/or analyzed.

The diagnostic laboratory systems described herein use vision systems that capture images of the sample containers and/or the contents (e.g., samples) contained in the sample containers. The captured images are then used to identify the sample containers and/or the contents of the sample containers. For example, the diagnostic laboratory systems may include vision-based artificial intelligence (AI) models and/or networks that are configured to provide fast and noninvasive methods for sample container identification.

Diagnostic laboratory systems may include sample handlers that may be the gateway for sample containers entering the diagnostic laboratory systems. Many diagnostic laboratory systems include machine vision located in or operative in conjunction with the sample handlers that are used to identify sample container characteristics such as geometry, capped condition, tube color, cap color, and other container and/or cap characteristics. Based on these characteristics, trained sample container identification networks identify the sample container types. Other instruments within diagnostic laboratory systems may also capture images of sample containers and the sample container identification networks may identify the sample container types after identifying the sample container characteristics.

The sample container identification networks may be trained on images of sample containers that were captured in controlled settings, such as under ideal lighting conditions. However, images captured under these controlled settings do not capture all the variations of sample container appearances that may be present when images are captured in actual use within sample handlers or other instruments/analyzers within diagnostic laboratory systems. For example, the appearance of a sample container that it is removed from refrigeration is different from when the sample container has been stored at room temperature for a time period. In addition, the appearance of a sample container may change as a result of handling and transportation. These changes may include minor dings and dents, slight changes in cap colors, and changes in label appearances. The sample container identification networks may not be trained to identify sample containers based on these real-world appearances that were not present under imaging conditions used to initially train the sample container identification networks.

In addition to the foregoing, sample container identification networks in diagnostic laboratory systems may not be trained to identify newly-added sample containers types. As new sample container types are introduced into diagnostic laboratory systems, the employed sample container identification networks must be updated or “retrained” to be able to identify the new sample container types. Retraining the AI networks in conventional diagnostic laboratory systems is costly and time consuming because a very large number of different (new) sample container types need to be imaged and manually annotated in order to retrain the AI networks.

Embodiments of the systems and methods described herein overcome the problems with retraining sample container identification networks. Diagnostic laboratory systems are provided with deployed trained sample container identification networks that are trained using an initial data set of images of sample containers that may become obsolete over time. In particular, the deployed identification networks are retrained using core data sets that include data sets of images of sample containers or sample container types that reflect current conditions of sample containers in the diagnostic laboratory systems. The retrained identification networks are then able to identify sample containers under current conditions encountered in the diagnostic laboratory systems, such as new sample container types never encountered before.

A core data set may have enough variation in the images, so that when a sample container identification network is trained or retrained using the core data set, the identification network is able to identify the sample containers with good confidence (e.g., a high confidence level). In some embodiments, the core data set is smaller than an initial data set used to train the deployed sample container identification network, but has enough variation to enable the retrained identification network to identify sample containers under current conditions existing in a laboratory system. For example, the core data set may have, at most, half the number of images of sample containers or sample container types that are able to be identified by the deployed sample container identification network.

In some embodiments, new sample container images may be added to the core data set based on a defined heuristic. For example, if a sample container fails to be identified by the identification network, a determination may be made as to whether the sample container image should be added to the core data set. If the sample container image is added to the core data set, the identification network is retrained on the revised core data set, which enables the identification network to identify the previously unidentifiable sample container. In some embodiments, the core data set may include images of sample containers captured by imaging devices from a plurality of different diagnostic laboratory systems or a plurality of instruments in a single diagnostic laboratory system. Thus, the revised core data set may not be site specific.

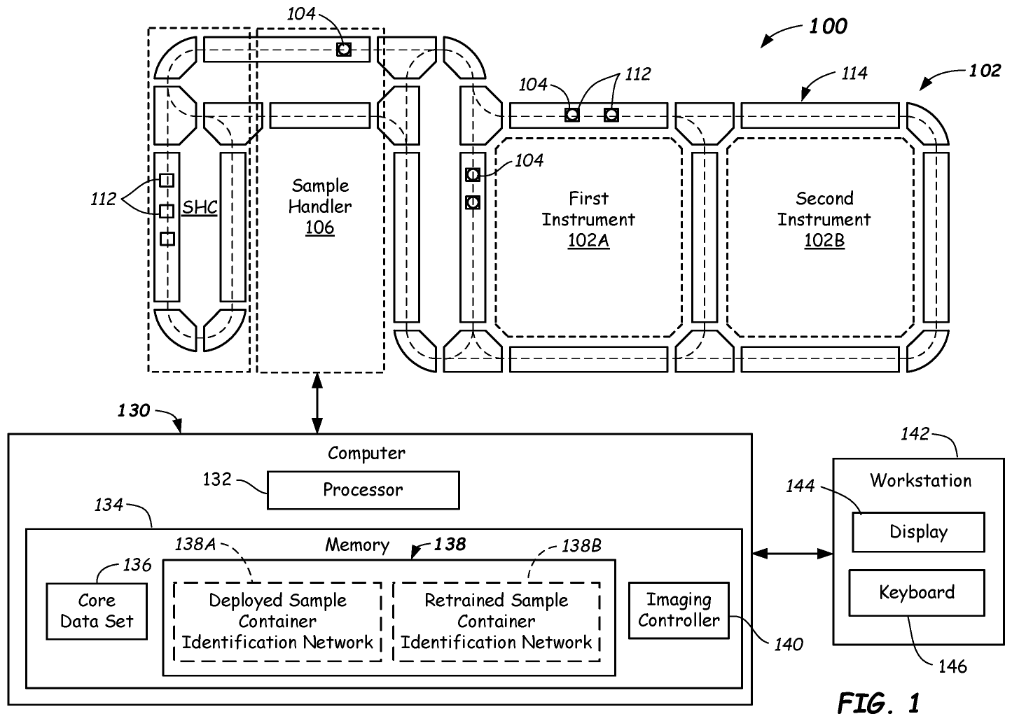

These and other systems and methods are described below in greater detail with reference to FIGS. 1-14 hereof.

Reference is now made to FIG. 1, which illustrates a block diagram of an example embodiment of a diagnostic laboratory system 100. The laboratory system 100 may include a plurality of instruments 102 configured to process the sample containers 104 (a few labelled) and to conduct assays or tests on samples located in the sample containers 104. The diagnostic laboratory system 100 may have a first instrument 102A and a second instrument 102B. Other embodiments of the laboratory system 100 may include more or fewer instruments.

The samples located in the sample containers 104 may be various biological samples (e.g., specimens) collected from individuals, such as patients being evaluated by medical professionals. The samples may be collected from the patients and placed directly into the sample containers 104. The sample containers 104 may then be delivered to the diagnostic laboratory system 100. Sample containers 104 may be loaded into a sample handler 106, which may be an instrument or component of the diagnostic laboratory system 100. From the sample handler 106, the sample containers 104 may be transported into sample carriers 112 (a few labelled) that transport the sample containers 104 throughout the diagnostic laboratory system 100, such as to the instruments 102, by way of a track 114. The track 114 is configured to enable the sample carriers 112 to move throughout the diagnostic laboratory system 100 including to and from the sample handler 106.

Components, such as the sample handler 106 and the instruments 102 of the diagnostic laboratory system 100, may include or be coupled to a computer 130 configured to execute one or more programs that control the diagnostic laboratory system 100. The computer 130 may be configured to communicate with the instruments 102, the sample handler 106, and other components of the diagnostic laboratory system 100. The computer 130 may include a processor 132 configured to execute programs including programs other than those described herein. The programs may be implemented in computer program code.

The computer 130 may include or have access to memory 134 that may store one or more programs and/or data sets described herein. The memory 134, data sets, and programs stored therein may be referred to as non-transitory computer-readable mediums. The programs may be computer program code executable on or by the processor 132. The memory 134 may store a core data set 136, which may be a set of images (e.g., image data) representative of sample containers used to train or retrain a sample container identification network 138. The core data set 136 may be revised or updated when certain conditions are met as described herein. The memory 134 may also include one or more data subsets that include sample container images that may or may not be included in the core data set 136. One or more of the data subsets may be selected as the core data set 136 as described herein.

The memory 134 may store a sample container identification network 138 (sometimes referred to herein simply as the identification network 138) that is configured to identify the sample containers 104. The identification network 138 may be implemented as computer code executable on the processor 132 and may include an AI model, such as one or more neural networks. The identification network 138 has a first state of a deployed sample container identification network 138A or simply a deployed identification network 138A and a retrained sample container identification network 138B or simply a retrained identification network 138B.

The deployed identification network 138A is the state of the identification network 138 initially present or deployed in the diagnostic laboratory system 100. The deployed identification network 138A is trained on a full training data set of images (e.g., a data set that may be large and difficult to use as a retraining source due, for example, to its size, particularly within an identification network) that may or may not be stored in the memory 134. The deployed identification network 138A is retrained using data in the core data set 136 to yield the retrained identification network 138B. In some embodiments, the identification network 138 may be retrained repeatedly as the core data set 136 is repeatedly updated.

In some embodiments, the identification network 138 may include a convolutional neural network (CNN) trained to identify the sample containers 104 by analyzing image data representative of the sample containers 104. As described herein, the identification network 138 is implemented using artificial intelligence (AI) configured to identify different types and/or configurations of the sample containers 104. The identification network 138 is not a lookup table but rather a supervised or unsupervised model or network that is trained to identify various types and/or configurations of the sample containers 104.

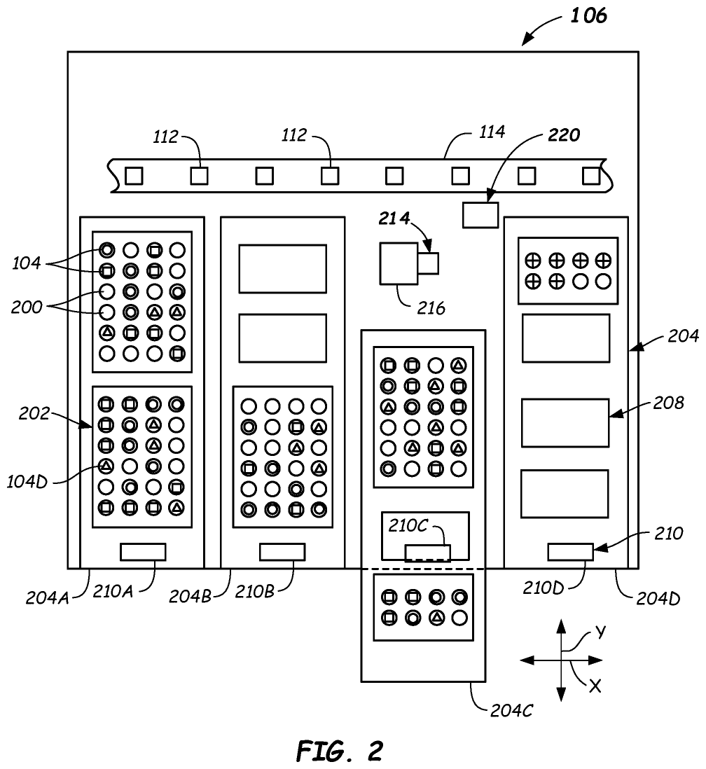

The identification network 138 identifies images of the sample containers 104 captured by at least one imaging device (not shown in FIG. 1; see imaging device 214 of FIG. 2, for example). In some embodiments, there may be relative movement between an imaging device and the sample containers 104 during imaging. Thus, the images may be video images or video data. The images may be captured within the sample handler 106, the instruments 102, or within other areas of the diagnostic laboratory system 100. In some embodiments, robots located in one or more of the instruments 102 and/or the sample handler 106 may be configured to move the imaging device 214 relative to the sample containers 104 to capture images of the sample containers 104. Additionally, the robots may be configured to move the sample containers 104 relative to the imaging device 214 to capture images, wherein the imaging device 214 may be provided at fixed locations.

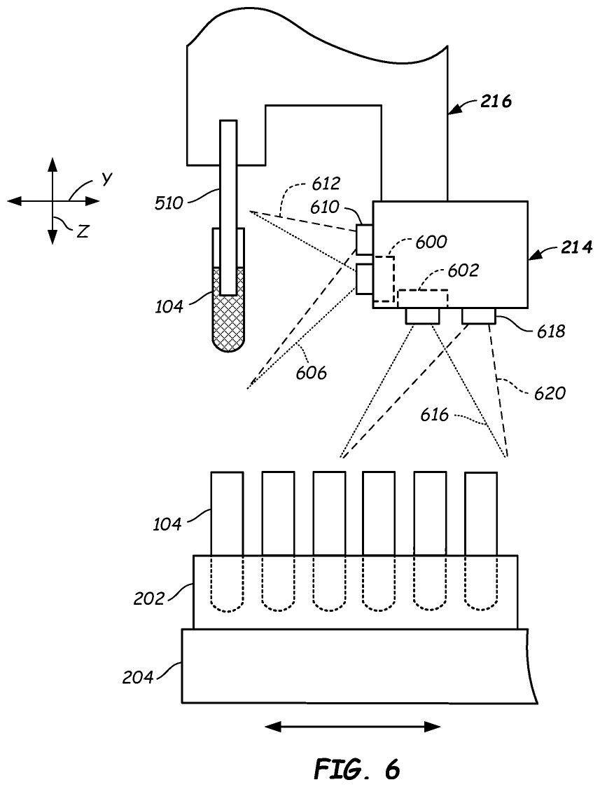

An imaging controller 140 may be implemented in the computer 130. The imaging controller 140 may be computer program code stored in the memory 134 and executed by the processor 132. The imaging controller 140 may be configured to control imaging devices (not shown in FIG. 1; see, imaging device 214 of FIG. 2, for example) and illumination sources (not shown in FIG. 1; see first illumination source 610 of FIG. 6, for example) to capture images under predetermined imaging conditions. For example, the imaging controller 140 may generate instructions that control settings of the imaging devices (e.g., cameras), such as setting predetermined frame rates and exposure times during imaging. The imaging controller 140 may also generate instructions that set the illumination intensity and one or more spectrums of light that illuminate the sample containers 104 during imaging. In some embodiments, the imaging controller 140 may also enable changing an image color(s) of captured images and may enable changing the brightness of the captured images. In other embodiments, the imaging controller 140 may enable cropping of captured images.

The computer 130 may be coupled to a workstation 142 that is configured to enable users to interface with the diagnostic laboratory system 100. The workstation 142 may include a display 144, a keyboard 146, and other peripherals (not shown). Data generated by the computer 130 may be displayable on the display 144. In some embodiments, the data may include warnings of anomalies detected by the identification network 138. The anomalies may include notices that certain ones of the sample containers 104 cannot be identified.

Users may enter data into the computer 130 by way of the workstation 142. The data entered by the user may be instructions that cause the core data set 136, the identification network 138, or the imaging controller 140 to perform certain operations such as capturing and/or analyzing images of sample containers 104 and retraining the identification network 138. Other data entered by a user may be decisions as to whether certain captured images of the sample containers 104 may be added to the core data set 136. Users may also manually augment images of sample containers using the workstation 142 and select viewpoints of images captured by the imaging devices.

Additional reference is now made to FIG. 2, which illustrates a top plan view of the interior of the sample handler 106 according to one or more embodiments. The sample handler 106 is a component of the diagnostic laboratory system 100 that receives the sample containers 104. Imaging devices within the sample handler 106 can be configured to capture images of the sample containers 104. Robots within the sample handler 106 are configured to transport the sample containers 104 between holding locations 200 (a few labelled) and the sample carriers 112 on the track 114.

In the embodiment of FIG. 2, the holding locations 200 may be receptacles that are located within trays 202 that may be removable from the sample handler 106. The sample handler 106 may include a plurality of slides 204 that are configured to hold the trays 202. In some embodiments, the sample handler 106 may include four slides 204 that are referred to individually as a first slide 204A, a second slide 204B, a third slide 204C, and a fourth slide 204D. The third slide 204C is shown partially removed (e.g., slid out from) from the sample handler 106, which may occur during replacement of trays 202. Other embodiments of the sample handler 106 may include fewer or more slides than are shown in FIG. 2.

Each of the slides 204 may be configured to hold one or more trays 202. In the embodiment of FIG. 2, the slides 204 may include receivers 208 that are configured to receive the trays 202. Receivers 208 may take any form (e.g., a pocket or recesses) that allows a respective tray 202 to be substantially fixed in the X-Y location relative to the slide 204 receiving it. Each of the trays 202 may contain a plurality of holding locations 200, wherein each of the holding locations 200 may be configured to receive one of the sample containers 104. In the embodiment of FIG. 2, the trays 202 may vary in size and may include large trays with twenty-four holding locations 200 and small trays with eight holding locations 200, for example. Other configurations of the trays 202 may include different numbers of holding locations 200 and holding locations configured to hold more than one sample container.

In some embodiments, the sample handler 106 may include one or more slide sensors 210 that are configured to sense movement of one or more of the slides 204. The slide sensors 210 may generate signals indicative of movement of the respective slides 204, wherein the signals may be received and/or processed by the computer 130 as described herein. In the embodiment of FIG. 2, the sample handler 106 includes four slide sensors 210 arranged so that each of the slides 204 is associated with one of the slide sensors 210. A first slide sensor 210A senses movement of the first slide 204A, a second slide sensor 210B senses movement of the second slide 204B, a third slide sensor 210C senses movement of the third slide 204C, and a fourth slide sensor 210D senses movement of the fourth slide 204D. Various techniques may be employed by the slide sensors 210 to sense movement of the slides 204. In some embodiments, the slide sensors 210 may include mechanical switches that toggle when the slides 204 are moved, wherein the toggling generates a signal indicating that a slide has moved. Slide sensors 210 can be configured to determine if the slides are slid out (open) or slid in (closed).

In some embodiments, the slide sensors 210 may be imaging devices that generate image data representative of top views of the sample containers 104. For example, the slide sensors 210 may generate image data as the sample containers 104 are moved (slid) into the sample handler 106. Thus, the image data may be video data captured as the slides 204 move relative to the slide sensors 210. The image data may be processed by the identification network 138 to identify individual ones of the sample containers 104. Additionally, the image data may be added to the core data set 136 as described herein.

The sample handler 106 may receive many different types of sample containers 104. A first type of the sample containers 104 are noted by triangles, a second type of the sample containers 104 are noted by squares, a third type of the sample containers 104 are noted by circles, and a fourth type of the sample containers are noted as crosses. Some of the plurality of holding locations 200 may be empty. The identification network 138 is configured to identify the sample containers 104 so that the sample containers 104 may be readily identified by the computer 130 (FIG. 1). The identification network 138 may also identify new types of sample containers 104 as described herein.

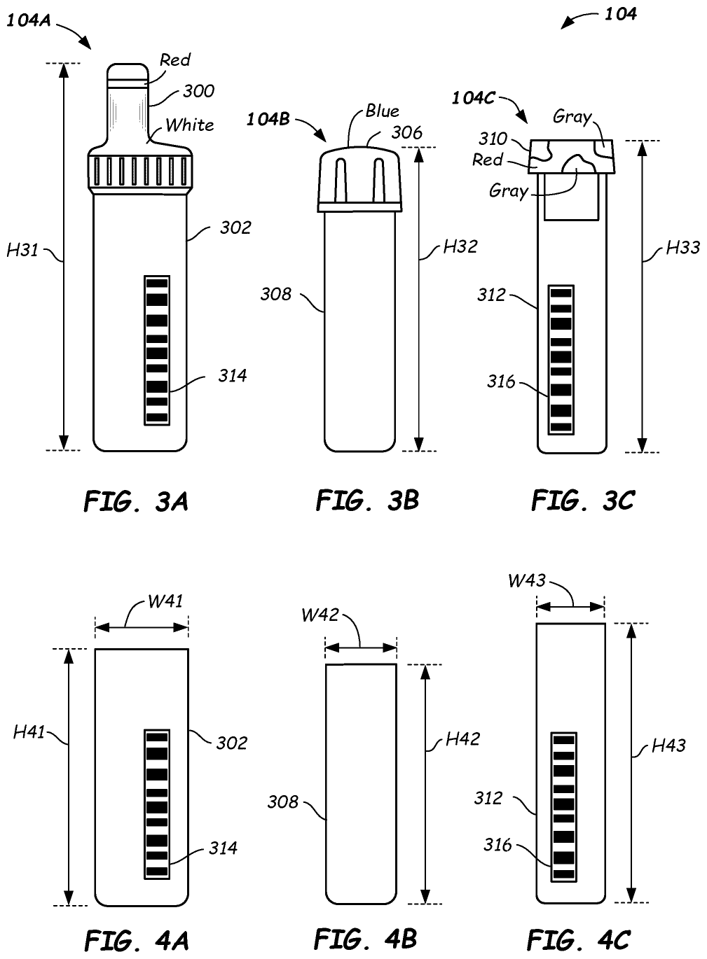

Additional reference is now made to FIGS. 3A-3C, which illustrate different types of example sample containers 104 that may be present within the diagnostic laboratory system 100. Other types of sample containers 104 may be present. In some embodiments, sample containers 104 may include tubes with or without caps attached to the tubes. Sample containers 104 may also include samples or other contents (e.g., liquids) located in the sample containers. Additional reference is also made to FIGS. 4A-4C, which illustrate the sample containers of FIGS. 3A-3C without the caps. As shown, all the sample containers may have different configurations or geometries. For example, the caps and the tubes of the different sample container types may each have different structural or color features, such as different tube and cap geometries and/or colors. The unique features of the sample containers 104 may be identified by the identification network 138 (FIG. 1) as described herein.

A first sample container 104A illustrated in FIG. 3A includes a cap 300 that is white with a red stripe and has an extended vertical portion smaller than a base portion coupled to the tube 302. The cap 300 may fit over or in the tube 302. The first sample container 104A has a height H31. FIG. 4A illustrates the tube 302 without the cap 300. The tube 302 has a tube geometry including a height H41 and a width W41. The tube 302 may also have features such as a tube color, a tube material, and/or a tube surface property (e.g., reflectivity). These dimensions, ratios of dimensions, and other material or color properties may be referred to as features and may be used by the identification network 138 to identify the first sample container 104A.

A second sample container 104B illustrated in FIG. 3B includes a cap 306 that is blue with a dome-shaped top and may fit over or in a tube 308. The second sample container 104B has a height H32. FIG. 4B illustrates the tube 308 without the cap 306. The tube 308 may have tube geometry including a height H42 and a width W42. The tube 308 also may have a tube color, a tube material, and/or a tube surface property. These dimensions, ratios of dimensions, and other properties may be referred to as features and may be used by the identification network 138 to identify the second sample container 104B.

A third sample container 104C illustrated in FIG. 3C includes a cap 310 that is red and gray with a flat top and may fit over or in a tube 312. The third sample container 104C has a height H33. FIG. 4C illustrates the tube 312 without the cap 310. The tube 312 also may have tube a tube geometry including a height H43 and a width W43. The tube 312 may have a tube color, a tube material, and/or a tube surface property. These dimensions, ratios of dimensions, and other properties may be referred to as features and may be used by the identification network 138 to identify the third sample container 104C.

The tube 302 can have identifying indicia in the form of a barcode 314 thereon. Likewise, tube 312 can have identifying indicia in the form of a barcode 316 thereon. Images of the barcode 314 and the barcode 316 may be analyzed by the identification network 138 to help identify the first sample container 104A and the third sample container 104C, or any other sample container 104 that has a barcode thereon.

Different types of the sample containers 104 (FIG. 1) may have different characteristics, such as different sizes, different surface properties, different caps, and/or different chemical additives therein as shown by the sample containers 104A-104C of FIGS. 3A-3C. For example, some sample container types are chemically active, meaning the sample containers 104 can contain one or more additive chemicals that are used to change or retain a state of the samples stored therein or otherwise assist in sample processing by the instruments 102 (FIG. 1). In some embodiments, the inside wall of the tube may be coated with the one or more additives or additives may be provided elsewhere in the sample container 104. In some embodiments, the types of additives contained in the tubes may be serum separators, coagulants such as thrombin, anticoagulants such as EDTA or sodium citrate, anti-glycosis additives, or other additives for changing or retaining one or more characteristics of the samples. For example, the sample container manufacturers may associate the colors of the caps on the tubes and/or shapes of the tubes or caps with specific types of chemical additives contained in the sample containers 104.

Different manufacturers may have their own standards for associating attributes of the sample containers 104, such as cap color, cap shape (e.g., cap geometry), and tube shape with particular properties of the sample containers. For example, the attributes may be related to the contents of the sample containers 104 or possibly whether the sample containers 104 are provided with vacuum capability. In some embodiments, a manufacturer may associate all sample containers 104 with gray colored caps with tubes including potassium oxalate and sodium fluorate configured to test glucose and lactate. Sample containers with green colored caps may include heparin for stat electrolytes such as sodium, potassium, chloride, and bicarbonate. Sample containers with lavender caps may identify tubes containing EDTA (ethylenediaminetetraacetic acid-an anticoagulant) configured to test CBC with differential, HgBA1c, and parathyroid hormone. Other cap colors such as red, yellow, light blue, royal blue, pink, orange, and black may be used to signify other additives or lack of an additive. In other embodiments, combinations of colors of the caps may be used, such as yellow and lavender to indicate a combination of EDTA and a gel separator, or green and yellow to indicate lithium heparin and a gel separator.

Since the sample containers 104 (FIG. 1) may be chemically active, it is important to associate specific tests that can be performed on samples with specific sample container types. Thus, the diagnostic laboratory system 100 may confirm that tests being run on samples in the sample containers 104 are correct by identifying the types of the sample containers 104 using the identification network 138 (FIG. 1).

Referring again to FIG. 2, the sample handler 106 may include an imaging device 214 that is movable relative to and/or throughout the sample handler 106. In the embodiment of FIG. 2, the imaging device 214 can be affixed to a robot 216 that is movable along an x-axis (e.g., in an x-direction) and a y-axis (e.g., in a y-direction) relative to the sample handler 106. In some embodiments, the imaging device 214 may be integral with the robot 216. In one or more embodiments, the robot 216 additionally may be movable along a z-axis (e.g., in a z-direction), which is into and out of the page. The robot 216 may be attached to the sample handler 106 or coupled to another structure located proximate to the sample handler 106.

The robot 216 may receive movement instructions generated by the imaging controller 140 (FIG. 1). The instructions may be data indicating x, y, and z positions that the robot 216 should move to. In other embodiments, the instructions may be electrical signals that cause the robot 216 to move in the x-direction, the y-direction, and the z-direction. The imaging controller 140 also may generate the instructions to move the robot 216 in response to one or more of the slide sensors 210 detecting movement of one or more of the slides 204. For example, upon detection of movement of one of the slides 204, the robot 216 may move to grasp a sample container or move the imaging device 214 proximate to one of the trays 202 or one or more of the sample containers 104. In some embodiments, the instructions may cause the robot 216 to move while the imaging device 214 captures images of the sample containers 104.

The imaging device 214 may include one or more cameras (not shown in FIG. 2; see first camera 600 of FIG. 6, for example) that capture images, wherein capturing images generates image data representative of the images. Camera as used herein is any imaging device capable of capturing an image (e.g., a digital image) that can be analyzed, such as a digital camera, a digital sensor such as a charge-coupled device (CCD), complementary metal-oxide-semiconductor (CMOS) sensor, metal-oxide semiconductor (MOS) sensor, Electron-multiplying charge-coupled device (EMCCD), or the like.

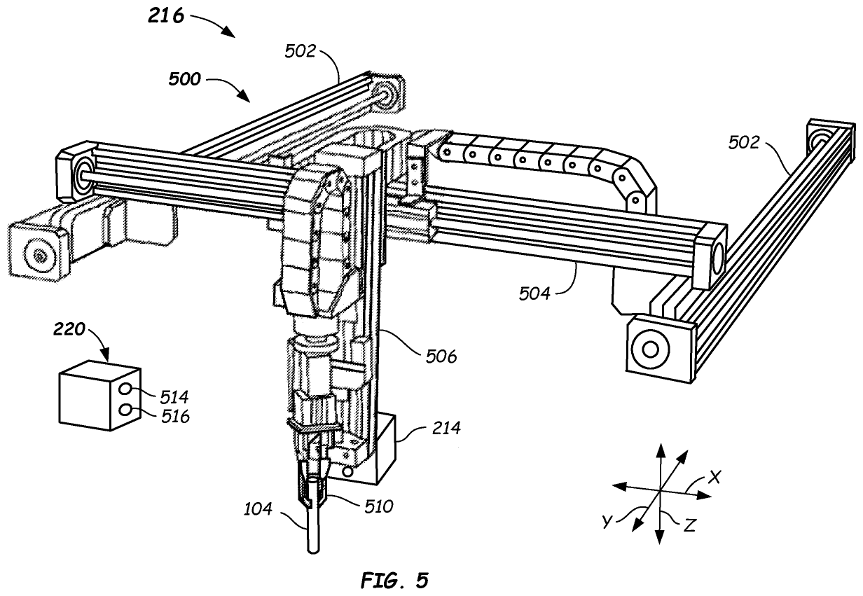

The image data may be transmitted to the computer 130 (FIG. 1) to be processed by the identification network 138 as described herein. The imaging device 214 is configured to capture images of the sample containers 104 and/or other locations or objects in the sample handler 106. The images may be tops and/or sides of the sample containers 104, for example. In some embodiments, the robot 216 may be a gripper-type robot that includes a gripper (e.g., gripper 510 of FIG. 5) that has fingers that grip the sample containers 104 and transports the sample containers 104 between the holding locations 200 and the sample carriers 112, and vice versa, for example. In some embodiments, the images may be captured while the robot 216 is gripping the sample containers 104. Movement of the imaging device 214 enables image capture of a sample container 104 from a first viewpoint followed by image capture of the sample container from one or more different viewpoints. The one or more different viewpoints may be augmentations of the images as described herein. An augmentation of an image is a subsequent image captured under different imaging conditions or otherwise modified as compared to an original image. In some embodiments, a user may input instructions to the workstation 142 that causes images to be captured from specific viewpoints by the imaging device 214.

Additional reference is made to FIG. 5, which is a perspective view of an embodiment of the robot 216 including a gantry 500 that is configured to move the gripper 510 of the robot 216 in the x-direction, the y-direction, and the z-direction. The gantry 500 may include two y-slides 502 that enable movement in the y-direction, an x-slide 504 that enables movement in the x-direction, and a z-slide 506 that enables movement in the z-direction. In some embodiments, movement in the three directions may be simultaneous and may be controlled by instructions generated by the imaging controller 140 (FIG. 1). For example, the imaging controller 140 may generate instructions that cause motors (not shown) coupled to the gantry 500 to move the slides in order to move the gripper 510 and the imaging device 214 to one or more predetermined locations or in one or more predetermined directions.

In some embodiments, the gripper 510 (e.g., an end effector) can be configured to grip the sample containers 104 (FIG. 2). A sample container 104 is shown being gripped by the gripper 510. The sample container 104 may be any one of the configurations of sample containers described in FIGS. 3A-4C, for example. The gripper 510 is moved to a position above a holding location 200 and then moved in the z-direction to retrieve a sample container 104 from the holding location 200. The gripper 510 opens and the robot 216 moves down in the z-direction so that the gripper 510 extends over the sample container 104. The gripper 510 closes to grip the sample container 104 and the robot 216 moves up in the z-direction to extract the sample container 104 from the holding location 200.

As shown in FIG. 5, the imaging device 214 may be affixed to a part of the robot 216, so the imaging device 214 may move with the robot 216 and capture images of the sample container 104 as well as of other sample containers 104 (FIG. 2) located in the sample handler 106. The imaging device 214 includes at least one camera configured to capture images, wherein the captured images are converted to image data for processing such as by the identification network 138. As described herein, the image data also may be used to update the core data set 136 (FIG. 1).

Additional reference is made to FIG. 6, which is a side elevation view of an embodiment of the robot 216 gripping the sample container 104D with the gripper 510 while the sample container 104 is being imaged by the imaging device 214. The imaging device 214 as depicted in FIG. 6 may include a first camera 600 and a second camera 602. Other embodiments of the imaging device 214 may include a single camera or more than two cameras. For example, additional cameras may be provided and aimed in the X direction or the Y direction opposite from the first camera 600. The first camera 600 has a field of view 606 extending at least partially in the y-direction and may be configured to capture images of the sample container 104 being gripped by the gripper 510. A first illumination source 610 may illuminate the sample container 104 in the field of view 606 by way of an illumination field 612. In some embodiments, the imaging controller 140 may be configured to control at least one of intensity of light emitted by the first illumination source 610 and a desired spectrum or spectra of light emitted by the first illumination source 610.

The second camera 602 may have a field of view 616 that extends in the z-direction and may capture images of the trays 202 (FIG. 2), the sample containers 104 (FIG. 2) located in the trays 202, and other objects in the sample handler 106. A second illumination source 618 may illuminate objects in the field of view 616 by an illumination field 620. In some embodiments, the spectrum, spectra, and/or intensity of light emitted by the second illumination source 618 may be controlled by the imaging controller 140 (FIG. 1).

The field of view 606 and the field of view 616 enable images of the tops (e.g., caps) and/or sides of sample containers 104 to be captured. For example, the top of the sample container 104 may be captured when the sample container 104 is located in one of the holding locations 200 (FIG. 2). The captured images may be analyzed by the identification network 138 (FIG. 1) to identify the sample container 104. In some embodiments, the imaging device 214 may have a single camera with a field of view that may capture at least a portion of the sample handler 106 and one or more of the holding locations 200 with or without the sample containers 104 located therein. Field of view 606 enable an image of the top (e.g., cap) and/or side of sample container 104 as being grepped by gripper 510 to be captured These images may also be used to update the core data set 136 as described herein.

Referring again to FIGS. 2 and 5, the sample handler 106 may include one or more stationary imaging devices 220. In the embodiment of FIGS. 2 and 5, the sample handler 106 includes a stationary imaging device 220. The stationary imaging device 220 may capture images of the sample containers 104 located in the holding locations 200 or a sample container 104 held by the gripper 510 of the robot 216. For example, the robot 216 may move the sample containers 104 within a field of view of the stationary imaging device 220 so that the stationary imaging device 220 may capture images of the sample containers 104.

The stationary imaging device 220 may include a camera 514 and an illumination source 516. The camera 514 may be similar to and operate in a similar manner as the first camera 600 (FIG. 6) and the second camera 602 (FIG. 6). The illumination source 516 may be similar to and operate in a similar manner as the first illumination source 610 (FIG. 6) and the second illumination source 618 (FIG. 6). Accordingly, the camera 514 and the illumination source 516 may be operated by the imaging controller 140 and the images captured by the camera 514 may be used to identify the sample containers 104 and/or to update the core data set 136.

Referring again to FIG. 1, the diagnostic laboratory system 100 may include other cameras and illumination sources. All the cameras and illumination sources may be controlled by the imaging controller 140. The imaging controller 140 may set one or imaging conditions for these devices during imaging as described herein. For example, the imaging controller 140 may generate instructions that set exposure time, frame rate, illumination intensity, and/or illumination spectra or spectrum during image capture. In some embodiments, the identification network 138 may determine the imaging conditions. The image data generated by the cameras may be representative of video and/or still images.

The imaging conditions may be changed from one image to another, which is referred to as augmenting the images. A first image may be referred to as an original image and subsequent images captured under different imaging conditions may be referred to as augmented images. Many different imaging conditions may be used to augment the original image, such as changing lighting conditions, which may include changing the brightness of illumination of a sample container and/or spectra or spectrum of illumination, during imaging. The augmentation may also include changing image quality or using a different imaging device relative to the original image. In some embodiments, augmenting the image may include capturing an image of a sample container from a different viewpoint than was used to capture the original image. Yet, in other embodiments, augmenting an image may include cropping an image relative to the original image. In some embodiments, users of the diagnostic laboratory system 100 may set the imaging conditions for augmentation.

Referring again to FIG. 1, the operation of the diagnostic laboratory system 100 and methods of updating the core data set 136 and retraining the identification network 138 to the retrained identification network 138B will now be described. During operation of the diagnostic laboratory system 100, medical professional may order tests to be performed on biological samples collected from one or more patients. A technician collects the samples and places the samples in the sample containers 104. The sample containers 104 containing the samples are then delivered to the diagnostic laboratory system 100. Electronic instructions (e.g., computer code) detailing the tests to be performed on the samples may be transmitted from the medical professional or hospital information system (HIS) to the diagnostic laboratory system 100, such as to the computer 130, e.g., over an intranet system.

With additional reference to FIG. 2, a laboratory user receives the sample containers 104 and loads the sample containers 104 into holding locations 200 in the trays 202. The trays 202 are then placed onto the slides 204 and the slides 204 are slid into the sample handler 106. As the trays 202 are slid into the sample handler 106, the slide sensors 210 may capture images of the sample containers 104. The captured images may be used by the computer 130 to identify the holding locations 200 that are occupied with sample containers. The captured images may also be used by the identification network 138 to identify the sample containers 104 and/or to retrain the identification network 138 as described herein. For example, the images may be added to the core data set 136, which is the used to retrain the identification network 138 to the retrained identification network 138B.

After the sample containers 104 are received in the sample handler 106, other images of the sample containers 104 may be captured. Embodiments of the sample handler 106 including the imaging device 214 (FIG. 2) may employ the robot 216 to move the imaging device 214 to predetermined locations in the sample handler 106. When the imaging device 214 is at these predetermined locations, the imaging controller 140 may generate instructions that cause the second illumination source 618 (FIG. 6) to emit light having predetermined frequencies and/or intensities. The imaging controller 140 may also generate instructions that cause the second camera 602 to capture images under predetermined imaging conditions. The predetermined imaging conditions may include lighting conditions and/or camera settings, such as exposure time and the like.

Embodiments of the laboratory system 100 that include the first camera 600 (FIG. 6) may capture images of the sample containers 104 while the sample containers 104 are grasped by the robot 216. For example, the robot 216 may move to a predetermined position and remove a specific one of the sample containers 104 from one of the holding locations 200. The imaging controller 140 may then generate instructions as described herein that cause the first illumination source 610 to illuminate and the first camera 600 to capture images of the specimen container under one or more predetermined imaging conditions.

Embodiments of the diagnostic laboratory system 100 that include the fixed imaging device 220 (FIG. 2) may capture images of the sample containers 104 when the sample containers 104 are in a field of view of the fixed imaging device 220. The imaging controller 140 may generate instructions to operate the illumination source 516 and the camera 514 in a similar manner as the second illumination source 618 (FIG. 6) and the second camera 602 (FIG. 6) as described above. In some embodiments, the fixed imaging device 220 may be located within the sample handler 106 and may be configured to capture images of the tops of the sample containers 104. In other embodiments, the robot 216 may transport certain ones of the sample containers 104 into the field of view of the fixed imaging device 220 to capture images of the sample containers 104.

Some embodiments of the diagnostic laboratory system 100 may include imaging devices in other instruments and locations. For example, one or more of the instruments 102 may include one or more imaging devices that may be controlled by the imaging controller 140 as described herein. Image data generated by these imaging devices may be used by the identification network 138 to identify the sample containers 104. The image data may also be original images and augmented images and may be used to update the core data set 136 as described herein.

Images used to train the deployed identification network 138A may have been captured in a controlled setting outside of the diagnostic laboratory system 100. It is usually not possible to capture all the possible variations of the appearances of the sample containers 104 in these controlled settings. For example, the appearances of the sample containers 104 may change between when the sample containers 104 are removed from refrigeration and when the sample containers 104 have been at ambient temperature for a time period. The appearances of the sample containers 104 may also change during handling and transportation of the sample containers 104. For example, the sample containers 104 may receive minor dings and dents, cap colors may change due to frost or humidity, and identification indicia may change. The identification network 138 may not be able to identify the sample containers 104 with such variations when the deployed identification network 138A is trained on images captured in controlled settings.

The diagnostic laboratory system 100 described herein is configured to scale (e.g., update or retrain) the identification network 138 to be able to identify new sample container types and container variations of known (e.g., previously-identified) sample container types that the identification network 138 is not able to identify. The updating of the identification network 138 may be performed using self-supervised learning or a combination of self-supervised and supervised learning. The updating further includes updating the core data set 136 using one or more sample container images. Updating the core data set 136 may also be performed by self-supervised learning or a combination of self-supervised and supervised learning. The identification network 138 is then retrained to the state of the retrained identification network 138B using the updated core data set 136.

The core data set 136 is a data set of images of sample container types with enough variations so that when the identification network 138 is retrained using the core data set 136, the retrained identification network 138B functions similar to or better than the deployed identification network 138A. The deployed identification network 138A may have been trained on more data (e.g., images) than is in the core data set 136. Thus, the core data set 136 may be smaller than a training data set used to train the deployed identification network 138A or a previous version of the identification network 138. As described herein, when the identification network 138 fails to identify a particular sample container 104, images of that sample container 104 that was not able to be identified may be used to update the core data set 136 as described herein.

In some embodiments, a determination may be made as to whether newly-acquired images of sample containers 104 that were not able to be identified are to be added to the core data set 136. For example, an image of a sample container 104 that could not be identified may be displayed on the display 144. The user may then decide whether the image should be used to update the core data set 136 and input the decision into the workstation 142. For example, images of sample containers 104 that are being discontinued or that may not be used often may not be added to the core data set 136 in order to keep the core data set 136 small.

In some embodiments, the sample container 104 that could not be identified may have been previously identified under different imaging conditions. Failure to identify the sample container may be due to imaging conditions during imaging of the sample containers 104 used to train the deployed identification network 138A being different than the imaging conditions within the sample handler 106. In some embodiments, the different imaging conditions may be different lighting conditions. For example, the images used to train the deployed identification network 138A may have been captured under different brightness than the present brightness in the sample handler 106. The difference in lighting conditions may be caused by the illumination sources (e.g., the second illumination source 618—FIG. 2) emitting a different spectrum, spectra, or intensity of light than spectrum, spectra, or intensities of light used to capture images of sample containers 104 that were used to trained the deployed identification network 138A.

In some embodiments, the quality of images captured in the sample handler 106 may be different from the quality of images used to train the deployed identification network 138A. The difference in image quality may prevent the identification network 138 from identifying the sample container 104. For example, the cameras and/or the illumination sources in the sample handler 106 may have become dirty, which changes the image quality relative to images used to train the deployed identification network 138A. In other embodiments, characteristics of the cameras and/or the illumination devices may age, which may change the image quality.

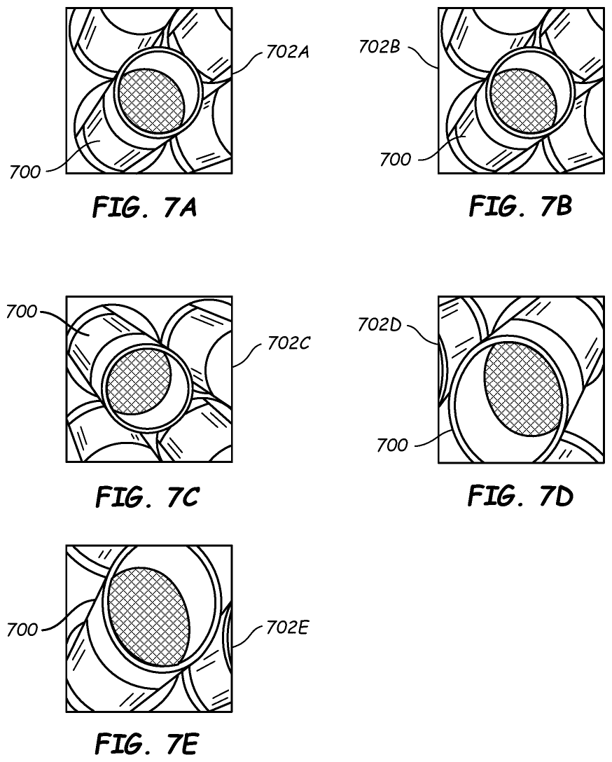

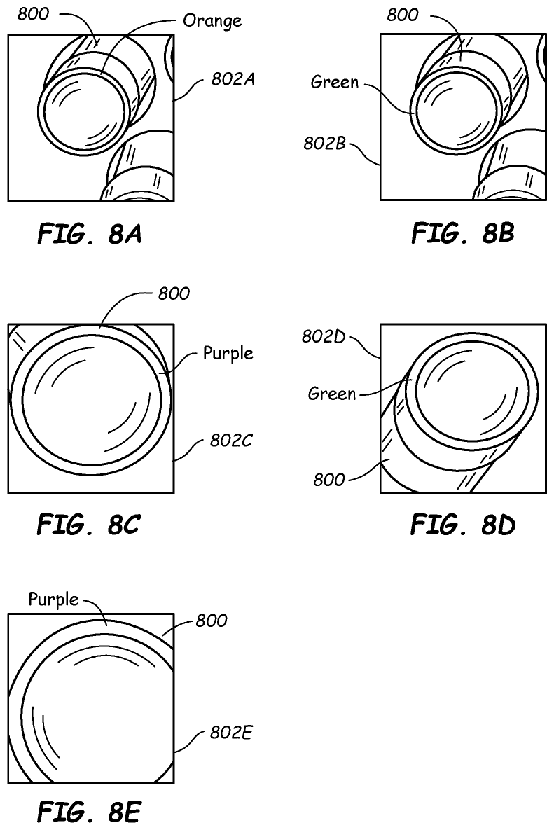

In order to simulate the different conditions that may be present within the diagnostic laboratory system 100 and to make the identification network 138 more accurate, augmented images of a sample container 104 that was not identified may be used to update the core data set 136. Additional reference is made to FIGS. 7A-7E and 8A-8E, which illustrate training images of sample containers that may be used in the core data set 136 to retrain the identification network 138.

FIGS. 7A-7E are top views of a first sample container 700, which may be a first type of the sample containers 104 (FIG. 1). FIGS. 8A-8E are top views of a second sample container 800, which may be a second type of the sample containers 104. FIG. 7A is an original image 702A of the first sample container 700 and FIG. 8A is an original image 802A of the second sample container 800. The views of FIGS. 7B-7E and FIGS. 8B-8E are additional images, which are augmented images of the original image 702A and the original image 802A, respectively. The views of FIGS. 7B-7E and FIGS. 8B-8E are generated through augmentation, such as color jittering, changing image brightness, scaling, changes in illumination color, cropping, reorienting viewpoint, and other changes relative to the original image 702A and the original image 802A. In some embodiments, the augmentations of FIGS. 7B-7E and FIGS. 8B-8E may be applied randomly. The augmented images and the original images may be used in contrastive learning in order to retrain the identification network 138 as described herein.

In some embodiments, the image 702B can be augmented by changes in brightness and color relative to the original image 702A. In others, the image 702C can be augmented by changes in the imaging angle (e.g., viewpoint) or pose and illumination color or spectrum relative to the original image 702A. The image 702D is augmented by a change in imaging angle and is also cropped and enlarged relative to the original image 702A. The image 702E is augmented by a change in color and is cropped and enlarged relative to the original image 702A.

The image 802B is augmented by a change in color relative to the original image 802A. The image 802C is augmented by changes in color and blurring (image quality) and is cropped and enlarged relative to the original image 802A. The image 802D is augmented by changes in color and viewpoint and is cropped and enlarged relative to the original image 802A. The image 802E is augmented by changes in imaging angle, blur, and color and is cropped and enlarged relative to the original image 802A.

In some embodiments, the identification network 138 may be trained or retained to the retrained identification network 138B using a combination of a classification loss function and a contrastive loss function that use the augmented images. The goal of the classification loss function is to find a proper partitioning of the images into groups that represent correct sample container type classifications. The classification loss function may be performed by minimizing entropy between the output of the identification network 138 and a target class, which has a side effect of bringing objects from a same class together. The target class is a class of similar images. In contrastive learning, a network is created that embeds data into a vector space. A loss function is employed which attempts to cause similar images to map to similar vectors and dissimilar images to map to dissimilar vectors. Once trained, the retrained network has learned how to embed images into a vector space that encodes information about the similarities of images. The trained network can then be trained for other tasks in less time and/or with less data.

The contrastive loss network attracts similar images and repels dissimilar images as described herein. There are different contrastive loss networks or models that may perform the function of attracting similar images and repelling dissimilar images. The operation of repelling dissimilar images may be optional in some networks. The attraction/repelling functions may be optimized by the identification network 138 through the loss, which means that the way images are attracted/repelled is loss dependent. In some embodiments, the attraction/repelling may be performed based on a triplet loss, which minimizes the distance between an anchor image and a positive image, both of which have the same identity. The triplet loss may also maximize the distance between the anchor image and a negative image, which has a different identity. In triplet loss, the anchor image is an original image, such as an original unaugmented image. Positive images are close to (e.g., similar to) the anchor image and negative images are far from (e.g., dissimilar from) the anchor image. The triplet loss encourages dissimilar pairs of images to be distant from any similar pairs of images by at least a certain margin value (loss value L) and may be defined by equation (1) as:

$$L = max ( d ( a , p ) - d ( a , n ) + m , 0 ) \qquad Equation ( 1 )$$

wherein:
a—the anchor image,
p—a positive image that has the same label as the anchor image a (the label may be vectors of an identified sample container),
n—a negative image that has a label different from the anchor image a,
d—a function to measure the distance between the three images, the anchor image a, the positive image p, and the negative image n,
m—a margin value to keep negative images far apart from each other.

In some embodiments, the contrastive loss may be calculated by InfoNCE loss (Info Noise Contrastive Estimation), which may be referred to as NT-Xent (normalized temperature-scaled cross entropy loss). (See, for example, Grill et al. “Bootstrap Your Own Latent A New Approach to Self-Supervised Learning,” Arxiv, arXiv: 2006.07733, 10 Sep. 2020, https://arxiv.org/abs/2006.07733.) Applying the InfoNCE loss may involve randomly sampling a batch of N images and defining a contrastive prediction task on pairs of augmented images derived from the batch, which results in 2N data points. Examples of the augmented images include FIGS. 7B-7E and FIGS. 8B-8E. In some embodiments, a contrastive loss function may be defined for a contrastive prediction task. (See, for example, Chen et al., “A Simple Framework for Contrastive Learning of Visual Representation,” Arxiv, arXiv: 2002.05709, 1 Jul. 2020, https://arxiv.org/abs/2002.05709?context=stat. ML.) For example, given a set {\dot{X}ₖ} of images including a positive pair of images \dot{X}ᵢ and \dot{X}ⱼ, the contrastive prediction function identifies \dot{X}ⱼ in {\dot{X}ₖ}_{k≠i} for a given \dot{X}ⱼ. Negative images may not be sampled explicitly. Rather, given a positive pair of images, such as \dot{X}ᵢ and \dot{X}ⱼ, the other 2(N−1) augmented images are treated within a batch as negative images. The method lets sim(u,v)=u^{T}v/∥u∥∥v∥, which denotes the dot product between the loss function [symbol] ₂ normalized u and v (i.e., cosine similarity).

Based on the foregoing, the loss function [symbol] _{(i,j)} for a positive pair of images (Xi, Xj) is defined by equation (2) as follows:

$${I}_{i , j} = - log \frac{exp ( sim ( {z}_{i} , {z}_{j} ) / τ}{{\sum }_{k = 1}^{2 N} {γ}_{k \neq i} exp ( sim ( {z}_{i} , {z}_{j} ) / τ} \qquad Equation ( 2 )$$

wherein: Y_{[k≠i]} E {0,1} is an indicator function evaluating to 1 if and only if k≠i and τ denotes a temperature parameter; the final loss may be computed across all positive pairs, both (i,j) and (j,i), in a batch, for example; (z) is the vector representation of images Xi and Xj after being processed by the identification network 138. An appropriate temperature parameter can help the model learn from hard negatives. In addition, an optimal temperature differs on different batch sizes and number of training epochs. Based on the loss function, the identification network 138 may be trained to identify images in close proximity to the similar images.

During the training stage, a cosine similarity may be computed between all images in a given batch. In some embodiments, a similar pair of images consists of different augmentations of an original image and negative images are other images in the batch. Similarities between the similar images are maximized against a noise, wherein the noise are dissimilar images. The processing may be equivalent to maximizing the Mutual Information (MI) between similar images while minimizing the MI between dissimilar images. In some embodiments, the loss function may be similar to a cross-entropy loss (classification loss) where each image in the batch has a different label between zero and the batch size. The difference with the classification loss is that the identification network 138 can: (1) control what it means to have similar images, (2) have a better chance to extract more rich features in the images because similar sample container types are closer to each other irrespective of sample container type.

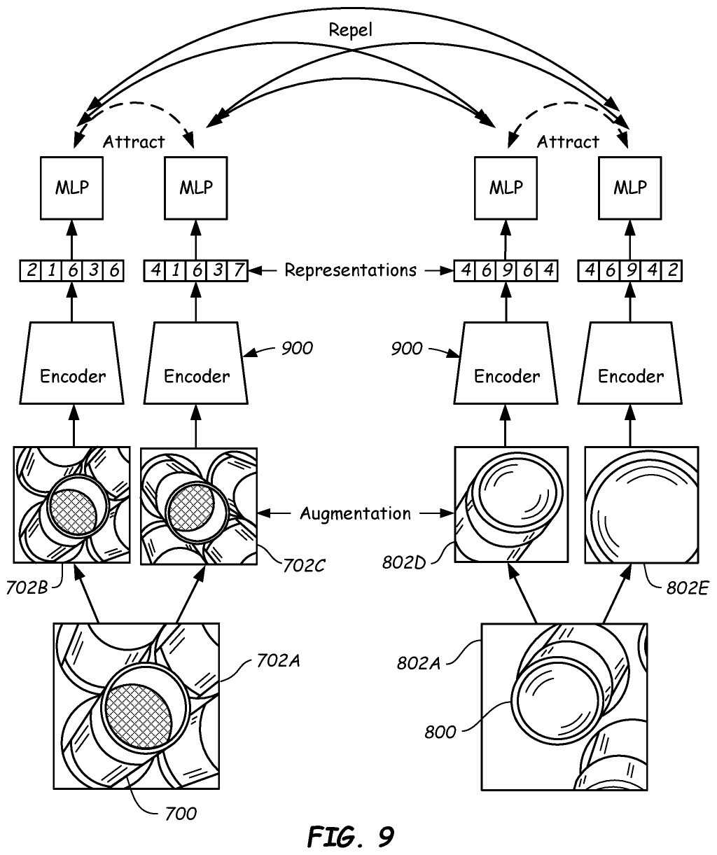

Additional reference is made to FIG. 9, which is a diagram illustrating an embodiment of contrastive learning according to one or more embodiments. The contrastive learning commences in FIG. 9 with the original image 702A of the first sample container 700 and the original image 802A of the second sample container 800. In the embodiment of FIG. 9, augmentations of the original image 702A and the original image 802A are performed. The augmentations are additional images that may be captured or otherwise generated. The images 702B, 702C, 802D, and 802E are examples of augmentations of the original image 702A and the original image 802A, respectively. Other augmentations may be included, but are not shown in FIG. 9. Each of the augmented images 702B, 702C, 802D, and 802E may be encoded by an encoder 900 to representations of each of the augmented images. In some embodiments, the original images 702A and 802A also may be encoded.

The encoder function may be a neural network implemented in the computer 130 (FIG. 1), such as in the identification network 138. A transformed image or feature map may be processed wherein the transformed image may be taken from the output of the neural network before the image is processed by a classification layer. The transformed image contains features extracted by the neural network. The transformed image may then be transformed or encoded into a single vector by conventional processes.

The representations output from the encoder 900 can be illustrated as arrays of values. Each element of the arrays may be an encoded item from the images and the value of the element represents the item or a condition of the item. For example, one element may be color and the value may be the average color. Another element may be cap configuration (e.g., capped, uncapped, or tube top sample cup) and the value may indicate the status of the cap. For example, a value of one may indicate an uncapped sample container and a value of two may indicate a capped sample container. Other elements may be related to geometric features of the sample containers and the values may be indicative of the geometric features. The description of the representations in the arrays of FIG. 9 are for illustration purposes and the outputs of the encoder 900 may be in other forms.

A multilayer perceptron (MLP) processes the representations and, based on the values from the encoder 900 described above, determines which images are similar and which images are dissimilar. For example, the values in the arrays may be compared to each other to determine like and dissimilar images. In the example of FIG. 9, similar images are attracted to each other and dissimilar images are repelled from one another. Such attraction and repulsion is used by a contrastive learning routine or network to train the identification network 138. Like images may be used to train the identification network 138 to learn different variations of the sample containers 104.

The contrastive learning may be used during training of the identification network 138. The outputs of the MLP in FIG. 9 may be vectors of size of (batch size x dimension), wherein the batch size is the number of images used in the batch during training and the dimension is the number of dimensions of representation vectors. The dimensions of the representation vectors may be any value (e.g., 1024). The representation vectors correspond to (z) in Equation (2). Because the loss function maximizes the mutual information (MI) between similar images and minimizes the MI between dissimilar images, the loss function may perform the attract/repel function as shown in FIG. 9.

Use of the contrastive learning described in FIG. 9 enables control over features that the identification network 138 (FIG. 1) may focus on to determine whether sample container images are similar. For example, the control may include weighting elements of the arrays to determine which images are similar or dissimilar. Weighting, for example, may determine how close values in different elements in the arrays need to be relative to each other in order for the images corresponding to different images to be considered similar. Sample container image similarities may include sample containers from the same manufacturer, sample containers having the same or similar colors, and sample containers having the same or similar shapes or geometric features. In addition, the identification network 138 may learn image representations introduced by extension (e.g., changes to the sample containers) and learn how to identify different imaging conditions, such as blurriness, camera conditions, lighting conditions, dings, dents, and, new tube colors.

In some embodiments, the identification network 138 may be configured to operate with a plurality of different imaging devices, wherein images captured with different imaging devices may comprise augmentations relative to the original images. The imaging devices may be configured to operate with different modalities, wherein image captured with the different modalities may be the augmentations. The modalities may include color, exposure time, illumination intensity, illumination spectra or spectrum, and other imaging conditions.

The workflow described in FIG. 9 may operate in at least two different configurations. In a first configuration, each of the different modalities, viewpoints, and/or other imaging conditions are considered augmentations of the original images 702A, 802A. In some embodiments, images captured from the different imaging conditions can undergo additional augmentation. The contrastive learning of FIG. 9 tries to bring similar sample container images of the different viewpoints, modalities, and/or other imaging conditions closer to each other while repelling images of different sample containers. In a second configuration. the images having different viewpoints, modalities, and/or other imaging conditions of an instance are augmented first then the images are grouped as one instance (by concatenation for example). The resulting image has a higher dimension and is a new augmented image.

The contrastive learning will then try to bring higher dimension images closer to each other while repelling augmentations of other images. Other types of self-supervised loss or contrastive learning, such as methods that do not rely on repelling dissimilar images, may be used to train the identification network 138.

When color cameras are used to capture images of the sample containers 104 (FIG. 1), the resulting images may have three color dimensions, which are color channels such as red, green, and blue (RGB). The images may then be described as a matrix of shape that includes the three color dimensions in addition to height and width, for example. If more modality is used, the images may have higher (e.g., more) dimensions. For example, if the images includes RGB data, depth data, and infrared (IR) data, the dimension are RGB+depth+IR, height, and width. Thus, the resulting dimension may be referred to as a matrix of (5, Height, Width), which can be referred to as a five dimensional image representation.

In some embodiments, the training may include capturing three images of different views of the sample containers 104, each with three color channels (e.g., RGB). The images may be concatenated along their RGB color channels. The resulting images have a matrix (3+3+3, height, width), which is a matrix (9, height width). Other methods of aggregating the images into matrices may be employed. In other embodiments, three-dimensional (3D) images may be created, which may have a four-dimensional matrices (3, number of images, height, width).

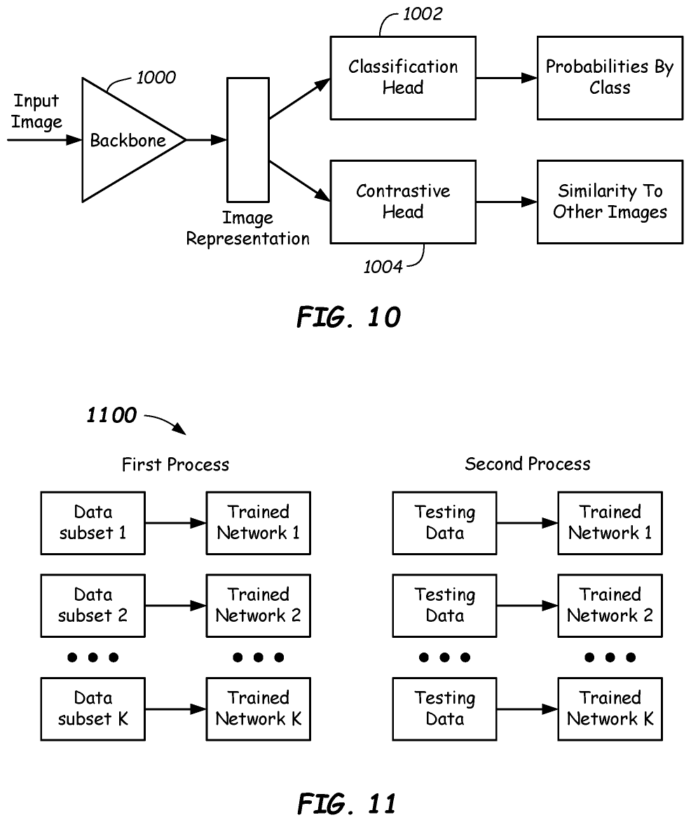

Additional reference is made to FIG. 10, which broadly illustrates an example of a network that may be implemented in the identification network 138 to train the identification network 138 per the workflow of FIG. 9. An input image is received at a backbone 1000, which, in some embodiments, may be a convolutional neural network (CNN). In some embodiments, the backbone 1000 may be an efficientNetV2 network. EfficientNetV2 networks are a family of CNNs that have faster training speed and better parameter efficiency than other CNNs. The EfficientNetV2 network includes a combination of training-aware neural architecture search and scaling to jointly optimize training speed and parameter efficiency. A final classification layer of the backbone 1000 may be removed. Other types of backbones may be used that yield representations of the input image. Examples of other backbones include deep networks, transformers, and principal component analysis (PCA).

During training, the image representation is then fed to both a classification head 1002 and a contrastive head 1004. In some embodiments, one or both the classification head 1002 and the contrastive head 1004 may be networks with a set of fully connected layers. In other embodiments, more complex networks may be used, such as by including Siamese branches in the contrastive head 1004. The contrastive head 1004 outputs data indicating whether the input image is similar to other images and which images the input image is similar to. The similarities are used in the contrastive learning described in FIG. 9. The classification head 1002 outputs a probability or confidence level that the input image is similar to the other images on which the backbone 1000 has been initially trained. In some embodiments, the confidence level is high (e.g., >95%) indicating a determination that the image has been classified or identified correctly. The output from the classification head 1002 and the contrastive head 1004 enable heuristic data of confidence level and similarity to be used to determine when to add images to the core data set 136 (FIG. 1) as described herein.

The classification head may consist of one or more linear layers and may output a probability or a likelihood that a sample container was properly identified. Similarities between images may be determined by way of K-Nearest Neighbors. Distances, which are likelihood of proper sample container identification, can be applied or used after processing by the classification head 1002 or the contrastive head 1004. In such embodiments, just computing any number of nearest neighbors and distances can be applied. In other embodiments, a cosine similarity as described above may be employed when the identification network 138 is trained to optimize similarities in the images.

The classification head 1002 and the contrastive head 1004 may operate by processing the augmenting images, which may be input into the same identification network 138. The images correspond to the image representations after the augmented images are processed by the backbone 1000 of FIG. 10. The contrastive head 1004 may have a projection layer and a prediction layer. The projection layer may include three linear layers, each followed by batch norm and activation layers (except for the last layer, which may be only a linear layer). The prediction layer may be one linear layer followed by a batch norm layer, an activation layer, and another linear layer. In some embodiments, the outputs of the projection and prediction layer are applied as in MocoV3 to train the identification network 138.

The training methods described herein use the core data set 136 (FIG. 1) to update or retrain the identification network 138 (FIG. 1). For example, the training updates the identification network 138 from the deployed identification network 138A to the retrained identification network 138B. The training methods also may repeatedly retrain or update the retained identification network 138B. The core data set 136 may be updated to include images that were not used in prior trainings of the identification network 138. The deployed identification network 138A may have been trained using a combination of images and may be retrained to the retrained identification network 138B using a different combination of images.

The same core data set 136 may be deployed with each individual laboratory system. The core data set 136 may be local to the laboratory system 100 or remote and accessible to the laboratory system 100 via a data network, for example. When images are to be kept for training, the images may be either sent to an additional database (local or remote) or added to the core data set 136, which may be local or remote. Updating the core data set 136 to create a new core data set 136 can be performed periodically to ensure the core dataset 136 has the best representation of images.

In some embodiments, images of new sample containers or images of sample containers previously used to update the core data set 136 are not deleted from the core data set 136 unless a user deletes the images. Updating the core data set 136 with images of the sample containers 104 enables the identification network 138 to be checked to determine whether the identification network 138 is functioning correctly after having been trained with the new images. Thus, the images may be used to perform a benchmark of the identification network 138. In addition, the laboratory system 100 may be able to revert to a previous version of the core data set 136, such as to the initial deployed core data set. Reverting to a previous core dataset may be performed if the laboratory system 100 or one or more of the instruments 102 was setup in a previous location and is moved to a new location. Reverting may also be performed if one of the instruments 102 becomes specialized for a given new type of sample container and needs to work completely with the new type of sample container.

In some embodiments, the laboratory system 100 may save space in the memory 134 (FIG. 1) by enabling image data to be sent to a remote location. The identification network 138 may recreate the core data set 136 from the remote image data. In some embodiments, the user may be given the option to delete images of sample container types that are not used to update the core data set 136.

The retraining may be self-supervised and may use augmented images of sample containers as described with reference to FIGS. 7 and 8. Retraining with heavily augmented images improves the performance and scalability of the identification network 138, but identifying sample containers 104 with entirely new designs and/or sample container images captured under very different imaging conditions may be difficult. The difficulty in identification is overcome with the systems and methods described herein. The core data set 136 may include a subset of sample container images used during original or subsequent training of the identification network 138. For example, the core data set 136 may include a subset of sample container images used to train the deployed identification network 138A. The subset of sample container images may have enough variation such that when the core data set 136 retrains the identification network 138, the retrained identification network 138B is able to identify the sample containers 104 with at least a predetermined confidence level. For example, the retrained identification network 138B may be able to identify the sample containers 104 with at least a confidence level greater than 0.95 (greater than 95%).

Additional reference is made to FIG. 11, which is a diagram describing a method 1100 of selecting a core data set 136 (FIG. 1) from a plurality of data subsets (e.g., data subsets of images), which may be referred to as training data subsets. The training data subsets are different data sets that include different sets or combinations of images that may further include augmented images as described herein. In some embodiments, data subsets may be generated (e.g., obtained) from at least a portion of a full training data set, each data subset including a different combination of sample container images obtained from the full training data set. In some embodiments, the methods described herein may be configured to generate a plurality of training data subsets. In summary, the method 1100 selects one of the plurality of training data subsets as the core data set 136. As described herein, the method 1100 tests the training data subsets against a benchmark data set and may select a training data subset with the best test results to be the core data set 136.

Different methods of selecting training data subsets may be employed. In some embodiments, the training data subsets may be based on granularity in sample container identification. Different levels of granularity can be defined depending on the type of annotation used for each sample container type. The level of granularity depends on how the data in the images is sampled and how the sample container types are defined, which by itself may affect how the tests on the samples are performed. The granularity may be coarse, such as being related to the types of sample containers. Examples of coarse granularity include determining whether sample containers in the images are uncapped, capped, sealed, etc. Examples of fine granularity include determining, from the images, whether sample containers are capped and the types of tests that are performed in the samples in the sample containers. Examples of even finer granularity include determining, from the images, whether sample containers are capped, the types of tests that are performed in the samples in the sample containers, and the sample container manufacturers.

The granularity may determine how the different training data subsets of sample container images are selected. For each training data subset, a certain number of images may be kept for training and the remaining images may be used for testing. One method of selecting training data subsets is by a subtractive method. The subtractive method includes generating a plurality of possible training data subsets, training identification networks on the training data subsets, testing on the testing data, and saving at least a metric of interest. The method further includes removing one or more subsets, training a new network on the remaining subsets, and testing on the testing data. If a metric of interest is within a threshold, the process is repeated with at least subsets. The process is continued while the performance is above the threshold and the number of subsets of data in the core data set 136 is greater than a target number of subsets. This process can also be repeated at the image level instead of the image subset level to reduce the number of images needed for processing.

Another method of selecting one of the training data subsets is an additive method. One or more subsets are selected, used for training, and tested. The performance is then checked. If the performance is better than a previous performance test, but below an acceptance threshold and the number of subsets is below a number of wanted subsets, one or more subsets are added. The performance is checked again until an acceptable performance is measured. The additive method may avoid having to completely retraining the identification network 138. Rather, the classification layer may be reset with possibly adding some network regularization. Thus, the additive method may be faster than the subtractive method.

In a first process of the method 1100, the different data subsets are used to train networks and thus generate trained networks. In the embodiment of FIG. 11, a first data subset 1 trains the network to form a first trained network 1, a second data subset 2 trains the network to form a second trained network 2, and a Kth data subset K trains the network to form a kth trained network K. A second procedure of the method 1100 operates to test each of the trained networks using testing data. The testing data may include as many sample containers types as possible, but it may not include all the sample container types from the present core data set 136. The testing data may include, for example, images of sample containers 104 that were not able to be identified by the identification network 138. The results of the tests may be compared to a benchmark and the data subset that generated the network that provides the best results may be selected as the core data set 136 (FIG. 1) or the data used to revise the core data set 136. The core data set 136 is then used to train or retrain the identification network 138 as described herein.

In some embodiments, some images of the sample containers 104 that cannot be identified by the identification network 138 are not added to the core data set 136. For example, the sample containers 104 that cannot be identified may be ready to be discontinued from use in the diagnostic laboratory system 100, so there is no need to use these sample containers 104 in the core data set 136. Other sample containers 104 may be rarely used and may not be added to the core data set 136.

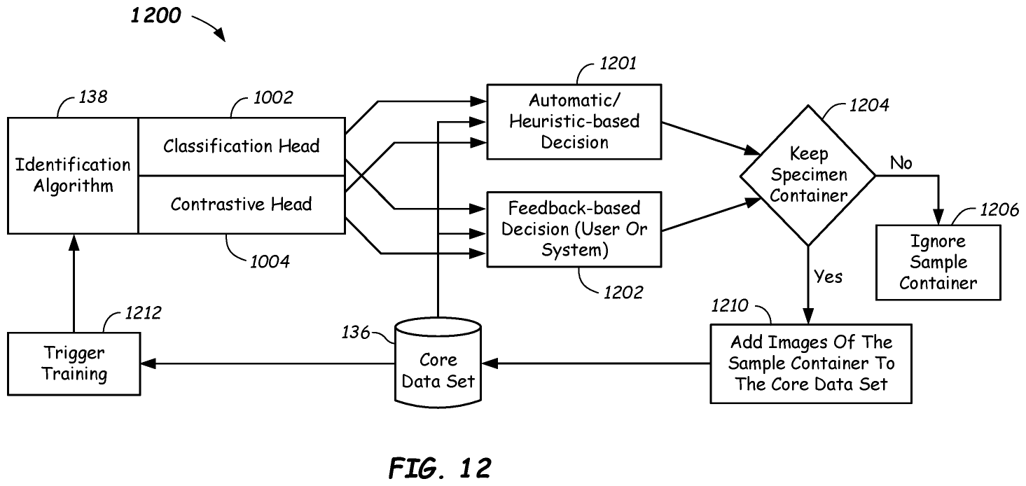

Additional reference is made to FIG. 12, which illustrates a flow diagram describing a method 1200 of determining whether images of sample containers 104 are to be added to the core data set 136 or the data subsets described in FIG. 11. The method of FIG. 12 may provide a heuristic determination as to whether the images of the sample containers 104 are to be added to the core data set 136. The method 1200 described in the flow diagram may be computer code implemented by the computer 130 (FIG. 1). The identification network 138 uses the AI described herein to identify a sample container 104, such as shown in FIG. 5 herein. The contrastive head 1004 can determine a similarity of the image to other images as described relative to FIG. 10. The classification head 1002 calculates a confidence level of the image identification made by the classification head 1002. In some embodiments, the contrastive head 1004 may be used to retrieve nearest neighbors of the image being processed from the core data set 136. For example, the contrastive head 1004 (FIG. 10) can be discarded and the nearest neighbors can be applied to the images (e.g., the image representations). In some situations, the results may be better by performing the process using the contrastive head 1004 because the contrastive head 1004 may have been optimized using cosine similarities between similar images as described above.

The nearest neighbor data may be used to enable decisions as to whether the image is similar to stored images. In some embodiments, the contrastive loss optimizes cosine similarities between different images. Similar images have the measure of the cosine similarity of their image representations close to 1.0 and dissimilar images have the measure of the cosine similarities close to −1.0.

Other measurements or distances can be used to compute similarities between images. For example, information related to the image representations may be generated. The image representations may be generated from the images shown in FIG. 9 as the output of either the classification head 1002 or the contrastive head 1004. When a similarity between images is to be computed, the cosine similarities between the image representations described above may be calculated to determine similarities. In some embodiments, Euclidian distances may be used to determine the distances between the image representations.

Data generated by both the classification head 1002 and the contrastive head 1004 are provided as inputs to heuristic processing block 1201 that performs an automatic heuristic-based decision and/or a feedback processing block 1202 that performs a feedback-based decision. The data (e.g., image data) in the original or previous core data set 136 is also input to both the heuristic processing block 1201 and the feedback processing block 1202. The heuristic processing block 1201 may use nearest neighbor results to determine how close the image is to other images as described above, for example.

In some embodiments, the feedback processing block 1202 defines more complex heuristic decisions based on a plurality of nearest neighbors generated by a nearest neighbor routine. The feedback processing block 1202 also may use a nearest neighbor routine to provide data to a user to retrieve feedback regarding the closeness of the image to other images. The images may be displayed on the display 144 (FIG. 1) and the user may use the workstation 142 to input information to the computer 130 regarding image similarities of the sample container 104. In some embodiments, the user may be able to produce a controllable latent space of a nearest neighbor routine by defining which sample container images should be closer to other sample containers, similar to the contrastive learning of FIG. 9.

According to the method 1200, a decision block 1204 can be provided that determines whether to keep the image of the specimen container 104 based on outputs of one or both of the heuristic processing block 1201 and the feedback processing block 1202. The decision may be based on the nearest neighbor routines and/or user input for example. The heuristic processing block 1201 can take the confidence from the classification head 1002 into the decision making. If the confidence is below a threshold, the heuristic processing block 1201 may query the core data set 136 to find the nearest neighbors. The user can either be notified of the nearest neighbor results right away or the user can be asked to check logs at certain times, such as at the end of the day. The decision in the heuristic processing block 1201 may analyze the specimen container images that triggered the heuristic analysis and compare the given sample container images with the similar sample container images. A determination as described herein can determine whether the sample container images should be added to the core data set 136.

If the decision of decision block 1204 is negative (No), the method 1200 proceeds to processing block 1206 where the image of the sample container 104 is ignored and not added to the core data set 136 or a data subset. If the decision of decision block 1204 is affirmative (Yes), the method 1200 proceeds to processing block 1210 where the image of the sample container 104 and/or augmented images of the sample container 104 are added to the core data set 136 or the data subsets of FIG. 11. Example of augmented sample container images are provided in FIGS. 7B-7E and 8B-8E.

After the core data set 136 is updated, the method 1200 can proceed to trigger block 1212 where retraining of the identification network 138 is again triggered. The retraining may be performed constantly, at scheduled times, or upon an input from the user. In some embodiments, a user may input information into the computer 130 (FIG. 1) via the workstation 142 that causes the identification network 138 to be retrained using the data in the core data set 136. The computer 130 may output a signal, such a signal displayed on the display 144 that indicates there is sufficient data available in the core data set 136 to retrain the identification network 138. In other embodiments, the identification network 138 may be retrained on a schedule, such as weekly or at times when the diagnostic laboratory system 100 is idle. In some embodiments, the core data set 136 may be transmitted to other diagnostic laboratory systems to update identification networks thereof. In yet other embodiments, the core data set 136 may be retrieved from a source external to the diagnostic laboratory system 100, such as from a server or another diagnostic laboratory system.

The core data set 136 may be a central core data set that receives updates or images from a plurality of different diagnostic laboratory systems. The central core data set may be deployed in the diagnostic laboratory system 100 to retrain the identification network 138. The central core data set may include images of a larger number of sample containers 104, so the identification network 138 may then be retrained to identify a large number of sample containers 104.

In some embodiments, the core data set 136 may be smaller than available data of all sample container types that are identifiable by the deployed identification network 138A. By “smaller than” it is meant that the core data set 136 contains fewer images than the number of images used to train the deployed identification network 138A. For example, the core data set 136 set may include at most half the total number of images of sample container types that the deployed identification network 138A was trained on. Augmentation of images of the sample containers 104 enables a low number of images per sample container type to be used during training and retraining. The augmentation may also keep the core data set 136 small because the images of the sample containers 104 may undergo extreme augmentation to create a large variation in new sample container images.

During training, the sample container images may undergo additional augmentation. By augmenting the images during training, only a few sets of each of the sample container images are needed because new sample container images may be created by augmenting the images. One of the challenges in augmentation is simulating light and reflection conditions for different sample containers. By saving images of the actual sample containers causing these issues, the challenging conditions in lighting conditions are saved. Then, the data augmentation can create new colors in the image and manipulate the images with perspectives, deformation, etc. in the augmented images.

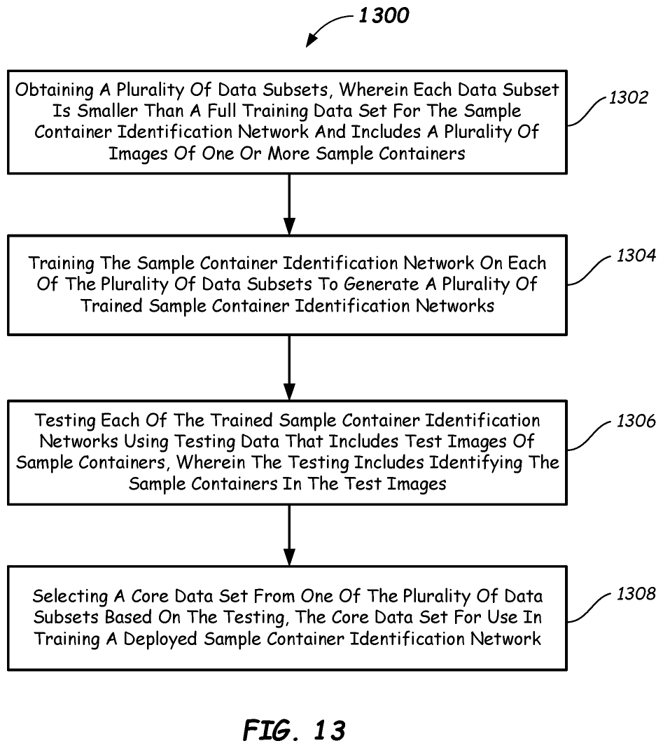

Reference is now made to FIG. 13, which illustrates a flowchart of a method 1300 of training a sample container identification network (e.g., identification network 138) of a diagnostic laboratory system (e.g., diagnostic laboratory system 100). The method 1300 includes, in block 1302, obtaining a plurality of data subsets, wherein each data subset is smaller than a full training data set for the sample container identification network 138 and includes a plurality of images of one or more sample containers (e.g., sample containers 104). The method 1300 includes, in block 1304, training the sample container identification network on each of the plurality of data subsets to generate a plurality of trained sample container identification networks. The method 1300 includes, in block 1306, testing each of the trained sample container identification networks using testing data that includes test images of sample containers 104, wherein the testing includes identifying the sample containers 104 in the test images. The method 1300 includes, in block 1308, selecting a core data set (e.g., core data set 136) from one of the plurality of data subsets based on the testing, the core data set for use in training a deployed sample container identification network.

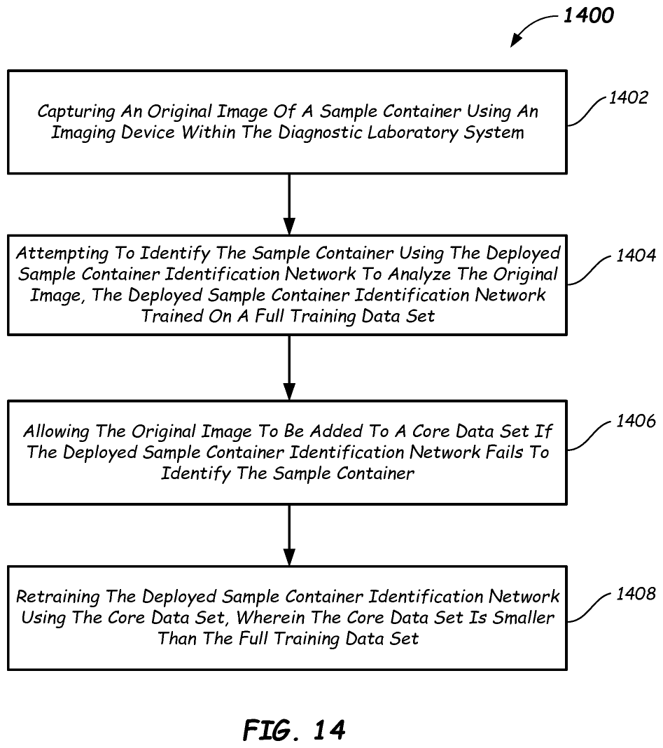

Reference is made to FIG. 14, which illustrates a flowchart of a method 1400 of retraining a deployed sample container identification network (e.g., identification network 138) of a diagnostic laboratory system (e.g., laboratory system 100). The method 1400 includes, in block 1402, capturing an original image of a sample container (e.g., sample container 104D) using a camera (e.g., imaging device 214) within the diagnostic laboratory system. The method 1400 includes, in block 1404, attempting to identify the sample container 104 using the deployed sample container identification network to analyze the original image, the deployed sample container identification network trained on a full training data set. The method 1400 includes, in block 1406, allowing the original image to be added to a core data set (e.g., core data set 136) if the deployed sample container identification network fails to identify the sample container. The method 1400 includes, in block 1408, retraining the deployed sample container identification network using the core data set, wherein the core data set is smaller than the full training data set.

While the disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure but, to the contrary, to cover all modifications, equivalents, and alternatives falling within the scope of the claims.

What is claimed is:

1. A method of training a sample container identification network of a diagnostic laboratory system, the method comprising:
obtaining a plurality of data subsets, wherein each data subset is smaller than a full training data set used to train the sample container identification network and includes a plurality of images of one or more sample containers;
training the sample container identification network on each of the plurality of data subsets to generate a plurality of trained sample container identification networks;
testing each of the trained sample container identification networks using testing data that includes test images of sample containers, wherein the testing includes identifying the sample containers in the test images; and
selecting a core data set from one of the plurality of data subsets based on the testing, the core data set for use in training a deployed sample container identification network.

2. The method of claim 1 further comprising using the core data set to train the deployed sample container identification network.

3. The method of claim 1 wherein obtaining a plurality of data subsets comprises:
obtaining a full training data set for the sample container identification network, the full training data set including a plurality of images of sample containers; and
generating the plurality of data subsets from at least a portion of the full training data set, each data subset including a different combination of sample container images obtained from the full training data set.

4. The method of claim 1, further comprising retraining the deployed sample container identification network using the core data set.

5. The method of claim 1, wherein obtaining the plurality of data subsets comprises capturing images of sample containers in the diagnostic laboratory system.

6. The method of claim 1, wherein obtaining the plurality of data subsets comprises:
capturing an original image of a sample container;
augmenting the original image of the sample container to generate one or more augmented images; and
using at least one of the original image and the one or more augmented images in at least one of the plurality of data subsets.

7. The method of claim 6, wherein augmenting the original image comprises capturing an image of the sample container under a lighting condition different than a lighting condition used to capture the original image.

8. The method of claim 7, wherein the lighting condition includes brightness of illumination of the sample container or a spectra or spectrum of illumination.

9. The method of claim 6, wherein augmenting the original image comprises capturing an image of the sample container having an image quality different than an image quality used to capture the original image.

10. The method of claim 6, wherein augmenting the original image comprises capturing an image of the sample container using an imaging device that is different than an imaging device used to capture the original image.

11. The method of claim 6, wherein augmenting the original image comprises at least one of capturing an image of the sample container from a different viewpoint than was used to capture the original image and cropping an image relative to the original image.

12. A method of retraining a deployed sample container identification network of a diagnostic laboratory system, the method comprising:
capturing an original image of a sample container using an imaging device within the diagnostic laboratory system;
attempting to identify the sample container using the deployed sample container identification network to analyze the original image, the deployed sample container identification network trained on a full training data set;
allowing the original image to be added to a core data set if the deployed sample container identification network fails to identify the sample container; and
retraining the deployed sample container identification network using the core data set, wherein the core data set is smaller than the full training data set.

13. The method of claim 12, further comprising:
determining a confidence level that the deployed sample container identification network identified the sample container; and
determining whether to include the captured image of the sample container in the core data set based on the confidence level.

14. The method of claim 12, further comprising adding one or more images from a deployed sample container identification network of a second diagnostic laboratory system to the core data set.

15. The method of claim 12, further comprising:
generating an additional image of the sample container by augmenting the original image of the sample container to generate an augmented image; and
adding the augmented image of the sample container to the core data set.

16. The method of claim 15, wherein generating the additional image comprises allowing a user to determine how to augment the captured image of the sample container.

17. The method of claim 15, wherein generating the additional image comprises automatically augmenting the original image to generate the augmented image.

18. The method of claim 15 wherein augmenting the original image comprises one or more of changing image brightness, changing image quality, changing illumination spectra or spectrum, changing image color relative to the original image, and cropping the original image.

19. The method of claim 15, wherein the original image is captured from a first viewpoint and wherein augmenting the original image comprises capturing an image of the sample container from a viewpoint other than the first viewpoint.

20. The method of claim 19, further comprising allowing a user to determine the viewpoint of the sample container.

21. The method of claim 12, wherein retraining the deployed sample container identification network comprises employing a combination of a classification loss function and a contrastive loss function during retraining.

22. The method of claim 12 wherein retraining the deployed sample container identification network comprises automatically retraining the deployed sample container identification network.

23. A diagnostic laboratory system, comprising:
a track;
a sample carrier moveable on the track and configured to receive a sample container including a sample;
an imaging device configured to capture images of the sample container;
a memory that includes a sample container identification network, the sample container identification network trained on a full training data set;
a computer coupled to the imaging device and the memory; and
computer program code that, when executed by the computer, causes the computer to:
employ the imaging device to capture an image of a sample container within the diagnostic laboratory system;
attempt to identify the sample container by analyzing the captured image using the sample container identification network;
add the captured image to a core data set if the sample container identification network fails to identify the sample container, wherein the core data set is smaller than the full training data set; and
allow the sample container identification network to be retrained using the core data set.

24. The system of claim 23, wherein the core data set is stored in the memory.

25. The system of claim 23, wherein the core data set is stored on a computer remote from the diagnostic laboratory system.

26. The system of claim 23, further comprising computer program code that, when executed by the computer, causes the computer to:
determine a confidence level that the sample container identification network identified the sample container; and
determine whether to include the captured image of the sample container in the core data set based on the confidence level.

27. The system of claim 23, further comprising computer program code that, when executed by the computer, causes the computer to add one or more images from another sample container identification network of a second diagnostic laboratory system to the core data set.

28. The system of claim 23, further comprising computer program code that, when executed by the computer, causes the computer to:
generate an additional image of the sample container by augmenting the image of the sample container; and
add the augmented image of the sample container to the core data set.

29. The system of claim 28, wherein the image is captured from a first viewpoint and wherein the augmenting comprises capturing an image of the sample container from a viewpoint other than the first viewpoint.

30. The system of claim 29, further comprising computer program code that, when executed by the computer, causes the computer to allow a user to determine the viewpoint of the sample container.
